(19) United States
(12) Patent Application Publication
(10) Pub. No.: US 2006/0235861 A1
(43) Pub. Date: Oct. 19, 2006

(54) Apparatus, system and method for supporting formation of customer-value creating scenario

(76) Inventors: Yasunori Yamashita, Tokyo (JP); Kenichi Funaki, Tokyo (JP); Hiroyuki Konno, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/386,868

(22) Filed: Mar. 23, 2006

(30) Foreign Application Priority Data
Mar. 24, 2005 (JP) 2005-085297

(51) Int. Cl. G06F 17/00

(52) U.S. Cl. 707/100

(57) ABSTRACT

A value extracted on the basis of a customer demand supports description of an appealing scenario leading to a requirement and a solution. Examples of customer-values include that which appears to be welcome for a customer, that which appears to be pleasant, and an object, and such can form requirements necessary for accomplishing customer-values such as those which must be done by employees, top executives, etc. of a customer, and those which must be done by an end user who is a customer of a customer, together with solutions necessary for realization of requirements, etc., as a customer-value creating scenario view including a causal relation. In addition, in order to hold attribute models, which differ depending on kind of node such as value, requirement and solution, it is possible to carry out automatic node extraction by utilizing the attribute model.

### BACKGROUND OF THE INVENTION

Customers desire solution proposals for solving problems which their own companies are facing. However, as it now stands, regardless of such a situation that solutions to be needed are different with respect to each customer, there are many uniform proposals such as ready-made products combination sale on a pamphlet basis, or, proposals no better than presenting a thing and a matter which are introduced, in many cases.

What a customer desires is a convincing proposal clearly showing what is a welcome thing, a pleasant thing and a thing to be targeted (value) for its own company in the first place, what must be done for realizing value (requirement), and what is a solution realizing the requirement (solution). That is a proposal in which a logical relation between a desired value and a solution is clear, and as a matter of course, an individual proposal which meets its own demand.

In this manner, in order to enable a solution proposal which satisfies an individual customer, desired is formation of a scenario from a value which is desired by a customer to a solution which reflects a demand with respect to each customer (hereinafter, called as value formation scenario). In addition, it is desired to always form a uniform scenario, regardless of a personal qualification of a person in charge in a solution vender.

For example, as a method of describing a value, there is an SCN (Strategic Capability Network) technique, and it is defined as follows.

SCN

By washing out corporate capability (Capability) and realization means (Enabler) which are necessary for creating a value (target and aim on business strategy), it is possible to logically represent a series of roads from a value to realization means. For example, see, “The practical methodlology of EA (Enterprise Architecture) and its values” (P67-73, IBM Professional Papers: 2004).

In addition, as a method of supporting node description, there is a structural model formation supporting method which is described in “Research regarding Demand Acquirement Supporting Method of Information System (1996)” etc., and it is defined as follows.

Structural Model Formation Supporting Method

In order to derive a reasonable solution in system demand analysis, problem analysis to a current condition is necessary. An object of this technique is to support a problem analysis process, and to provide formation means of a structural model easy to find out positioning of an individual problem in an entirety, drop-out/slip-out and overlapping, by visualizing a logical structure of a problem, and to support a node idea on the occasion that a person in charge, who has little work experience, forms a structural model. For example, see, “Research regarding Demand Acquirement Supporting Method of Information System (1996)” (“Structural Model Formation Supporting Method on Case Example Base” The Society of Instrument and Control Engineers, 15-th System Engineering Committee Study Group “Idea Supporting Technology” (1994 through 7) Shuji SOGA et al.)

However, in case of clarifying what is a value for a customer and forming a solution and a value formation scenario for realizing the value, there is the following problem which can not be solved by the above-mentioned conventional technology.

Firstly, a scope of picking up as a value is limited, and therefore, it is not possible to derive requirements and solutions which are really necessary for a customer. What is a value of a customer in SCN is an object on business strategy. A value for a customer is not only an object on business strategy, but also occurs in a welcome thing and a pleasant thing etc. If there is no description of the suchlike value depending on a viewpoint of a customer, it is not possible to extract a value which properly reflects a demand of a customer, and therefore requirements or solutions necessary to the customer cannot be derived eventually. That is, it is not possible to derive an appealing solution and to make a proposal.

Secondly, since each kind of nodes has different meanings, such as a value and a requirement, a solution, it must have an attribute which can describe a keyword representing each meaning.

Thirdly, a relevant value, requirement, solution can not be extracted automatically. On this account, it is not possible to broaden an idea from a demand of a customer, and it is not possible to obtain broadening in a solution to be derived. That is, it is not possible to derive an appealing solution, and to make a proposal.

### SUMMARY OF THE INVENTION

The present invention has been made in view of the above-mentioned each problem, and aims to extract a value on the basis of a demand of a customer, and to support description of an appealing scenario leading to a requirement and a solution.

The invention holds data for defining a relation between respective nodes in advance, by using a value, a requirement and a solution as a node. Then, it supports to broaden a value, a requirement and a solution which are specific to a customer, on the basis of an existing scenario, by use of the above-mentioned data.

That is, the present invention provides a customer-value creating scenario formation supporting apparatus which supports formation of a scenario for deriving a solution which is coupled to a value of a customer, wherein the apparatus comprises data storage means which holds attribute data that is composed of a name and an attribute of a node described in the scenario, the node meaning a value, a requirement and a solution, abstract relation data that rules a hierarchical relation between the nodes on a conceptual basis, and causal relation data that rules a causal relation between the nodes, node description means which describes the node inputted from a user, in the scenario, contribution factor extraction means which extracts a node relating to a node described by the node description means, by use of the attribute data, abstract relation data and causal relation data, and adds it to the scenario, solution extraction means which extracts a node that becomes a solution of the node described by the node description means and the node extracted by the contribution factor extraction means, by use of the attribute data, abstract relation data and causal relation data, and adds it to the scenario, and scenario output means which presents a new scenario having a node described by the node description means, a node added by the contribution factor extraction means, and a node added by the solution extraction means, to a user.

According to the invention, it is possible to extract a value on the basis of a demand of a customer, and support description of an appealing scenario leading to a requirement and a solution.

### BRIEF DESCRIPTION OF THE DRAWINGS

FIG. 1 is a system block diagram of a customer-value creating scenario description supporting system in this embodiment.

FIG. 2 shows one example of template data in this embodiment.

FIG. 3 shows one example of attribute data in this embodiment.

FIG. 4 shows one example of abstract relation data in this embodiment.

FIG. 5 shows one example of causal relation data in this embodiment.

FIG. 6 shows one example of a scenario describing screen in this embodiment.

FIG. 7 shows one example of customer profile data in this embodiment.

FIG. 8 is a processing flow of customer-value creating scenario formation supporting processing in this embodiment.

FIG. 9 is a processing flow of contribution factor extraction processing in this embodiment.

FIG. 10 shows one example of an extraction condition setup screen in this embodiment.

FIG. 11 shows one example of an extraction result screen in this embodiment.

FIG. 12 shows one example of a causal relation search condition setup screen in this embodiment.

FIG. 13 shows one example of a causal relation extraction result display screen in this embodiment.

FIG. 14 is a processing flow of solution extraction processing in this embodiment.

### DETAILED DESCRIPTION OF THE PREFERRED EMBODIMENTS

Hereinafter, an embodiment of the invention will be explained with reference to accompanying drawings. In the embodiment, it is possible to describe “a welcome thing and a pleasant thing for a customer, and an object etc. as customer-values”, and to form requirements necessary for accomplishing customer-values such as a thing which must be done by employees, top executives etc. of a customer and a thing which must be done by an end user who is a customer for a company of a customer, and solutions necessary for realization of requirements, etc., as a customer-value creating scenario view including a causal relation. In addition, because attribute models respectively different to each other are provided for variety of nodes, for instance, a value, a requirement, and a solution, automatic node extraction can be attained by utilizing such attribute models.

Hereinafter, in the present embodiment, a user indicates a person in charge in a sales department who makes a solution proposal, or a person in charge in a consulting department, or a person in charge in an SE department, or a person in charge in a business planning department, or a person in charge in a sales planning department, and depending on circumstances, a customer, etc.

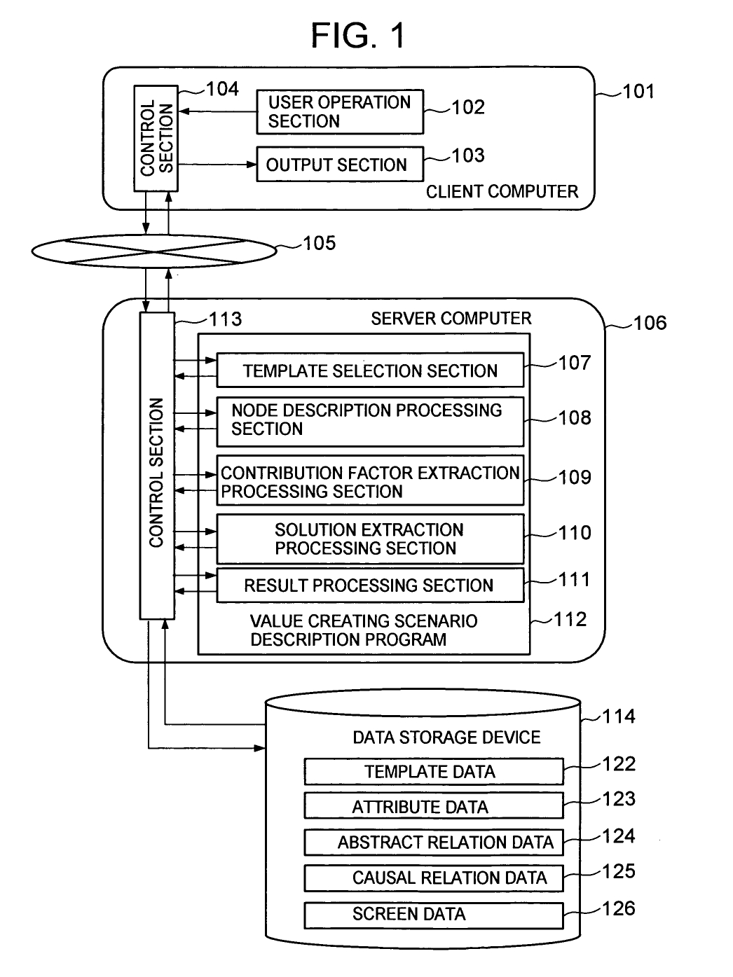

FIG. 1 is a system block diagram of a customer-value creating scenario description supporting system in this embodiment.

As shown in this figure, the customer-value creating scenario description supporting system in this embodiment is equipped with a client computer 101, a server computer 106, a communication network 105 to which the both sides are connected, and a data storage device 114.

The data storage device 114 holds each data necessary for processing in the server computer 106. Concretely speaking, it holds template data 122, attribute data 123, abstract relation data 124, causal relation data 125, and screen formation data 126. It transfers held data to the server computer 106, in accordance with a request from the server computer 106.

The client computer 101 is equipped with a user operation section 102, an output section 103, and a control section 104.

The user operation section 102 accepts an input from a user. In this embodiment, it receives an input such as, for example, customer profile data which is information of a customer, node data which was newly described, and a node extraction instruction. Details of the node data and the node extraction instruction will be described later.

The control section 104 controls an entire client computer 101. Concretely speaking, the control section 104 transmits customer profile data received by the user operation section 102, newly described node data, a node extraction instruction etc. to the server computer 106 through the network 105. In addition, the control section 104 receives various data transmitted from the server computer 106 side, and processes data so as to be able to be outputted, and outputs the data from the output section 103.

The output section 103 outputs data in accordance with an instruction of the control section 104. For example, the output section 103 displays and prints a customer-value creating scenario view.

The server computer 106 is equipped with a template selection section 107, a node description processing section 108, a contribution factor extraction processing section 109, a solution extraction processing section 110, a result processing section 111, and a control section 112.

The template selection section 107 extracts a template which can be utilized for formation of a customer-value creating scenario among the template data 122 which is held in the data storage device 114, in accordance with an instruction from a user. That is, the template selection section 107 extracts template data which matches to a predetermined item of customer profile data among the template data, by use of the customer profile data and template data 122 which are transferred from the control section 113. the template selection section 107 transfers the extracted template data to a control section 113 as template narrowing-down data.

The node description processing section 108 generates a node to be added to a template. When receiving an instruction from a user through the control section 113, the node description processing section 108 generates a node in accordance with the instruction from the user. Concretely speaking, the node description processing section 108 generates attribute data 123 of each node, and transmits the attribute data generated to the client computer 101 as information of a node to be added to and displayed on a scenario.

The contribution factor extraction processing section 109 extracts a node which relates to an existing node. That is, when receiving a node extraction instruction from a user through the control section 113, the contribution factor extraction processing section 109 extracts a node in accordance with a contribution factor extraction processing flow which will be described later, by use of the attribute data 123, the abstract relation data 124 and the causal relation data 125. Then, the contribution factor extraction processing section 109 transfers contribution factor extraction data which is a processing result, to the control section 113.

The solution extraction processing section 110 extracts a solution node which shows a solution relating to an extracted node. That is, when receiving a solution extraction instruction from a user through the control section 113, the solution extraction processing section 110 extracts a solution node from the attribute data 123, the abstract relation data 124 and the causal relation data 25, in accordance with a solution extraction processing flow which will be described later. Then, the solution extraction processing section 110 transfers solution extraction data which is a processing result, to the control section 113.

The result processing section 111 adds various data which was newly registered by a user at the time of scenario formation, to each data of the data storage device 114, which will be described later, and saves the various data.

The control section 113 controls the entire server computer 106. In this embodiment, the control section 113 receives customer profile data which is transmitted from the client computer 101 through the communication network 105, information relating to a newly described node, a node extraction instruction, a template selection instruction, etc., and transfers them to a relevant function section. Then, the control section 113 receives a processing result in each function section, and transfers the processing result to a relevant function section, or transmits the processing result to the client computer 101.

For example, the control section 113 receives customer profile data from the client computer 101, and holds the customer profile data. The control section 113 reads the template data 122 from the data storage device 114, and transfers the template data to the template selection section 107, together with customer profile data. When receiving the template narrowing-down data which is a processing result in the template selection section 107, the control section 113 transmits the template narrowing-down data to the client computer 101. When receiving an instruction of a template selection from the client computer 101, the control section 113 transmits the selected template data 122 and scenario describing screen formation data among the screen formation data 126, to the client computer 101.

The control section 113 transfers information relating to a node accepted from the client computer 101, to the node description processing section 108.

When accepting a contribution factor extraction instruction which is a node extraction instruction for extracting a contribution factor from the client computer 101, the control section 113 reads the attribute data 123, the abstract relation data 124 and the causal relation data 125 from the data storage device 114, and transfers them to the contribution factor extraction processing section 109. When receiving the contribution factor extraction data which is a processing result, from the contribution factor extraction processing section 109, the control section 113 transmits the contribution factor extraction data to the client computer 101.

When accepting a solution extraction instruction which is a node extraction instruction for extracting a solution, from the client computer 101, the control section 113 reads the attribute data 123, the abstract relation data 124 and the causal relation data 125 from the data storage device 114, so as to transfer to the solution extraction processing section 110. When receiving the solution extraction data which is a processing result, from the solution extraction processing section 110, the control section 113 transmits the solution extraction data to the client computer 101.

When accepting an instruction of registration which will be described later, from the client computer 101, the control section 113 registers a scenario formed during the period of the above-mentioned processing, the attribute data 123, the causal relation data 125 etc., in the data storage device 114.

Next, detail of each data, which is held in the data storage device 114, will be explained.

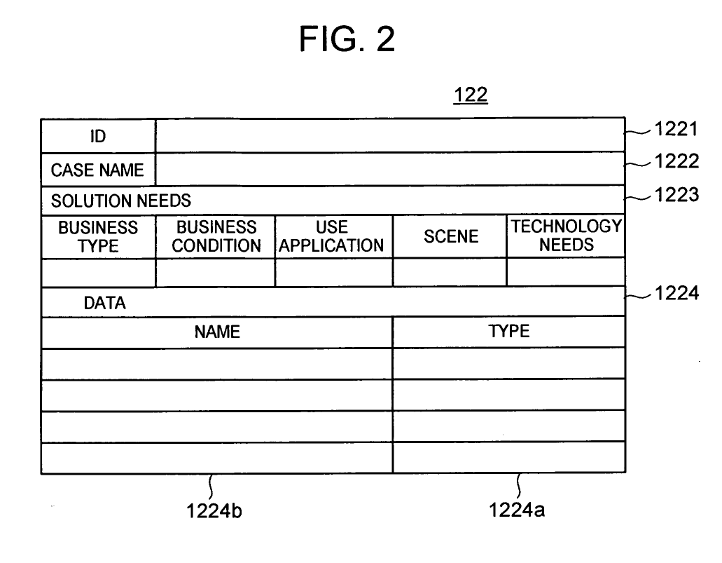

The template data 122 holds constituent elements of a scenario screen and information for specifying the template data 122. One example of the template data 122 is shown in FIG. 2. As shown in this figure, the template data is equipped with a template ID storage column 1221 for storing a template ID which is given for specifying template data with respect to each template data, a case name storage column 1222 for storing a case name, a solution needs profile storage column 1223, and a data storage column 1224 for holding data of nodes and arcs which are displayed in each area of a scenario screen.

The solution needs profile storage column 1223 is equipped with a business type storage column, a business condition storage column, a use application storage column, a scene storage column and a technology (restriction) needs storage column. There is no such a necessity that solution needs profile storage column 1223 is all necessarily specified. For example, in case of a template which can be utilized without regard to all business types, business conditions and so on, data showing “not specified” is stored in a storage column of any solution needs profile storage column 1223.

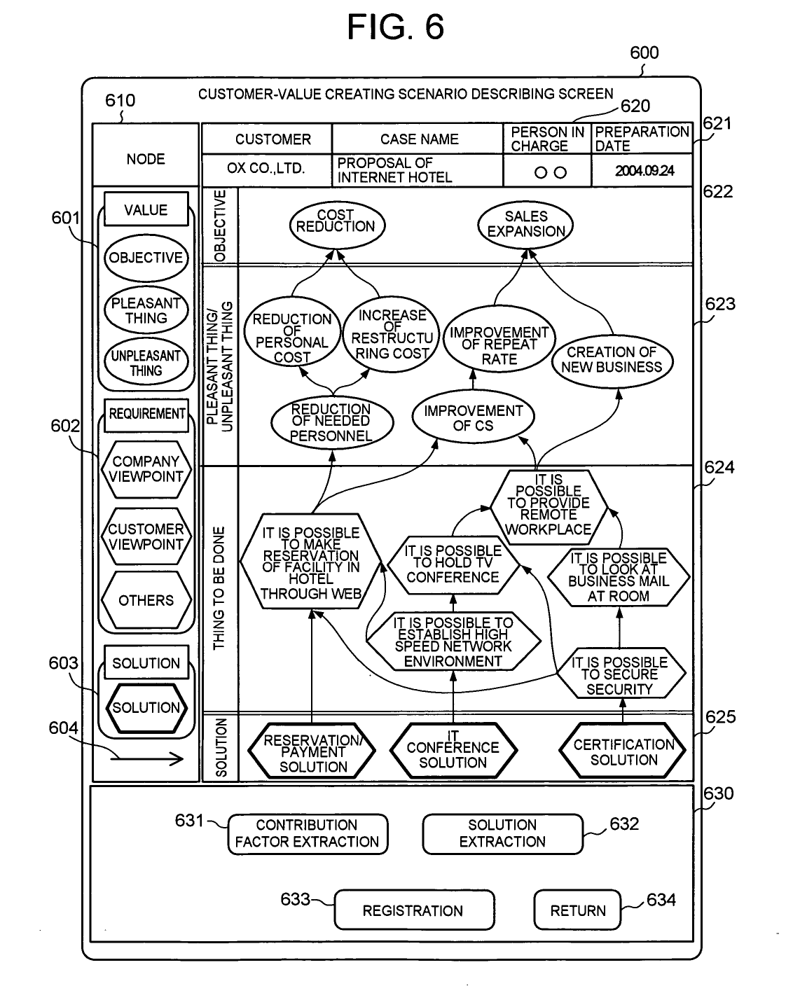

In addition, the data storage column 1224 is equipped with a name storage column 1224a and a type etc. storage column 1224b. All nodes and arcs to be displayed are stored in the data storage column 1224. In case that a node is stored in the name storage column 1224a, a type of the node is stored in the type etc. storage column 1224b, and in case that an arc is stored in the name storage column 1224a, information for specifying nodes of a connection source and a connection destination is stored in the type etc. storage column 1224b. By use of these information, the control section 104 of the client computer 101 can display a scenario describing screen 600 shown in FIG. 6 which will be described later, on the output section 103.

Meanwhile, the template data 122 is registered by a user in advance. Furthermore, what is formed as a scenario is added and registered as new template by the result processing section 111. Thereby, the template data is enriched each time of creation of the scenario.

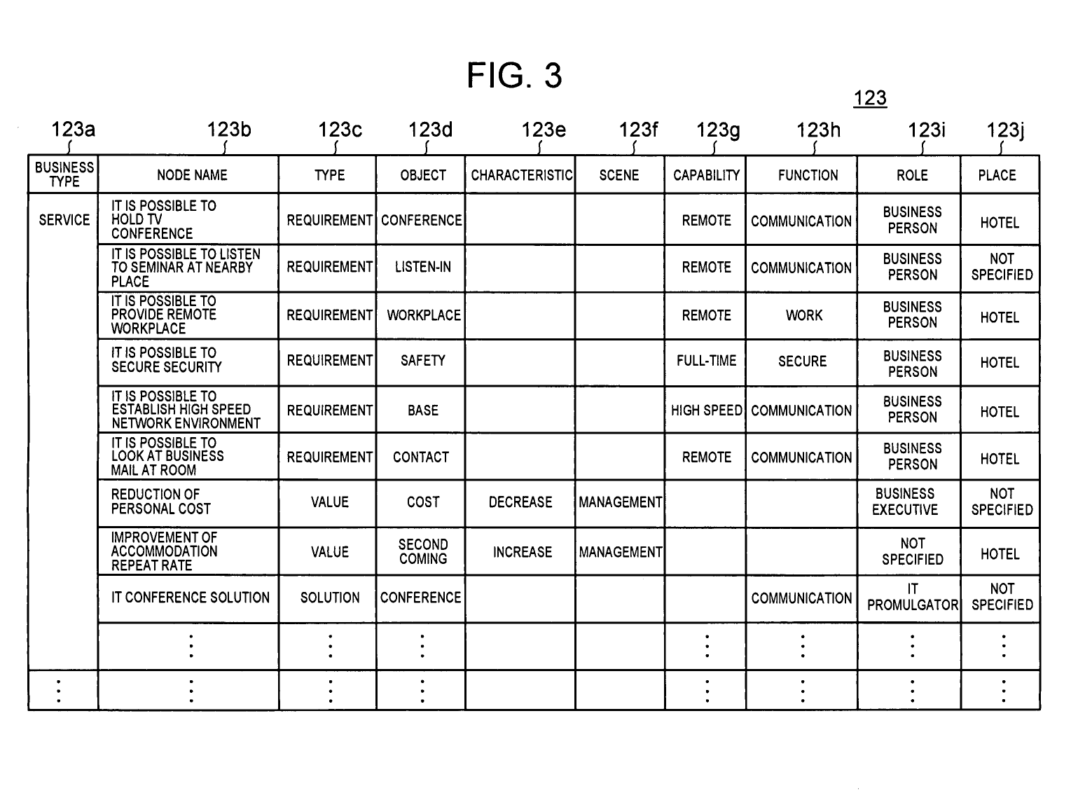

The attribute data 123 is data for holding nodes with respect to each business type and attributes of their nodes. One example of the attribute data 123 is shown in FIG. 3. As shown in this figure, the attribute data 123 is equipped with a business type storage column 123a for storing a business type name, a node name storage column 123b for storing a node name to be described in a scenario, a type storage column 123c for storing a type showing whether a node is a node which is used as any one of a value, a requirement and a solution, an object column 123d, a characteristic column 123e, a scene column 123f, a capability column 123g, a function column 123h, a role column 123i, and a place column 123j for storing an object, a characteristic, a scene, capability, a function, a role and a place which are attributes of each node, respectively. Here, it does not mean that something is stored in all of the object column 123d, the characteristic column 123e, the scene column 123f, the capability column 123g, and the function column 123h, with respect to each node, and attributes to be stored are determined in advance depending on a type of a node. Hereinafter, in this embodiment, attributes to be stored in these columns are referred as an individual attribute. On one hand, attributes are stored in the role column 123i and the place column 123j with regard to all nodes. Hereinafter, in this embodiment, attributed to be stored in these columns are referred as a common attribute.

Meanwhile, the attribute data 123 is registered by a user in advance. In addition, in case when a new node description is carried out by a user at the time of scenario formation, it is additionally registered by a business type, by the result processing section 111.

The abstract relation data 124 stores a hierarchical relation of each concept, relating to a common attribute of each node which is stored in the attribute data 123. By use of the hierarchical relation of a concept of this abstract relation data 124, a node to be described at the time of scenario formation is added.

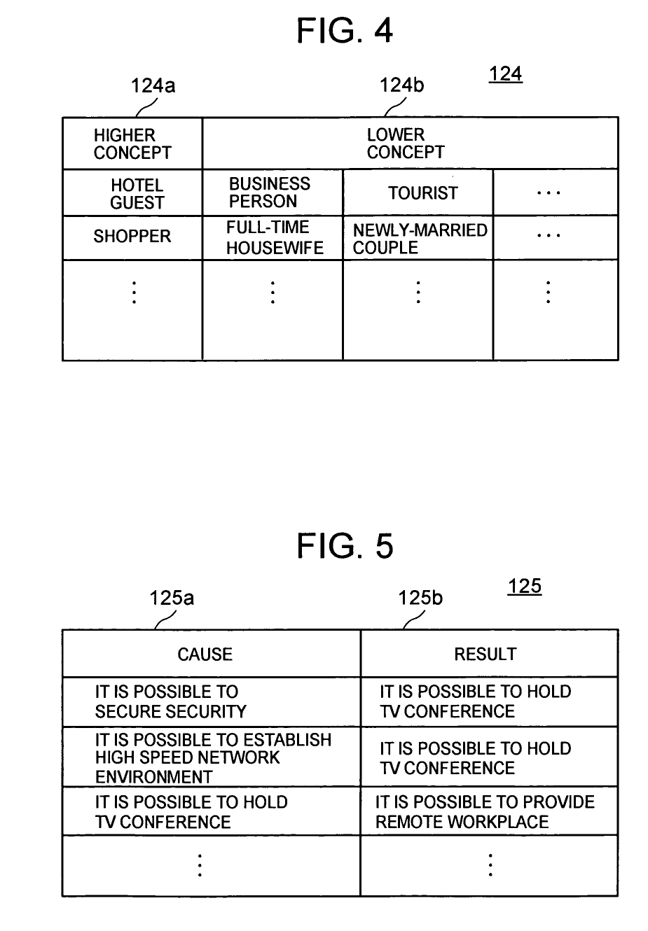

FIG. 4 shows one example of the abstract relation data 124. As shown in this figure, the abstract relation data 124 is equipped with a higher concept storage column 124a for storing a higher concept of each item, and a lower concept storage column 124b. Definitions of the higher concept and the lower concept of each attribute are formed by utilizing a commonly used thesaurus etc., and registered by a user in advance.

The causal relation data 125 holds a causal relation between respective nodes. In accordance with a relation defined in this causal relation data 125, node to be described at the time of scenario formation is added, and a solution is derived. FIG. 5 shows one example of the causal relation data 125. As shown in this figure, the causal relation data is equipped with a cause storage column 125a for storing a node which becomes a cause, and a result storage column 125b for storing a node of a result which can be derived by a node stored in the cause storage column 125a. This data is also registered by a user in advance. In addition, it is all right even if it is configured in such a manner that, in case when an input of an arc from a user is received at the time of scenario formation, it is newly additionally registered by the result processing section 111, in accordance with a direction of the arc.

The screen formation data 126 holds data which configures a screen for displaying on the output section 103 of the client computer 101. In this embodiment, it is equipped with scenario describing screen formation data which is data which becomes a basis for forming the scenario describing screen 600 by use of the template data 122 and displaying it on a display screen of the output section 103 of the client computer 101, extraction condition setup screen formation data which will be described later, extraction result screen formation data, causal relation search condition setup screen formation data, causal relation extraction result screen formation data and so on.

One example of the scenario describing screen 600, which is formed and displayed by the scenario describing screen formation data, is shown in FIG. 6.

As shown in this figure, the scenario describing screen 600 is equipped with a tool area 610, a scenario area 620, and an instruction button area 630.

The tool area 610 prepares nodes and arcs which are described in the scenario area 620. Nodes are prepared for a value node column 601, a requirement node column 602, and a solution node column 603, respectively, with respect to each type of each node, and an arc is prepared for an arc column 604. Meanwhile, an arc is an arrow for showing a connection between nodes, and the arrow is headed from a node which becomes a cause to a node which becomes a result. On the occasion of registering it in the causal relation data 125, it follows this.

The scenario area 620 is equipped with a title column 621 for displaying information which specifies an object of this scenario such as a customer name, a case name, a name of a person in charge, and a creation date, an objective node description area 622 for describing an objective node for this scenario formation, a value node description area 623 for describing a value node, a requirement node description area 624 for describing a requirement node, and a solution node description area 625 for describing a solution node.

The instruction button area 630 is equipped with a contribution factor extraction button 631 for receiving a contribution factor extraction instruction, a solution extraction button 632 for receiving a solution extraction instruction, a registration button 633 for receiving an instruction for registering the above-described node, and a “return” button 634 for receiving an instruction for returning a node to a situation prior description, without carrying out registration.

The control section 104 of the client computer 101 displays data of nodes and arcs which is stored in the data storage column 1224 of the template data 122, on the objective node description area 622, the value node description area 623, the requirement node description area 624, and the solution node description area 625, respectively, in accordance with a type stored in the type storage column 123c, of the attribute data 123, and displays them on the output section 103 as a scenario describing screen.

Meanwhile, the above-described client computer 101 and server computer 106 can be attained by a commonly used information processing device which is equipped with CPU, a memory, a storage device and so on. CPU of the server computer 106 realizes each function of the template selection section 107, the node description section 108, the contribution factor extraction processing section 109, the solution extraction processing section 110 and the result processing section 111, by loading a value formation scenario description program 112 stored in a storage device, in a memory and executing it. Meanwhile, the server computer 106 holds the customer profile data 121 which was transmitted from the client computer 101, in a storage device etc., on a temporary basis, so as to use for subsequent processing.

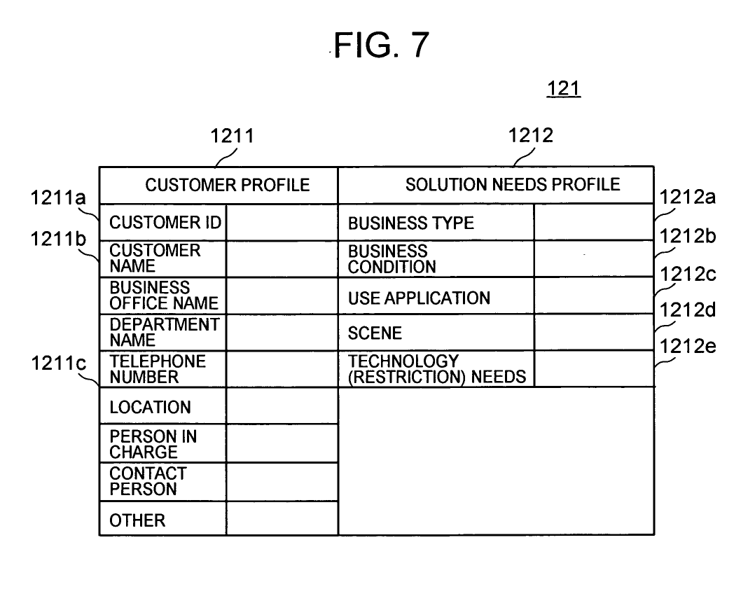

Here, one example of the customer profile data 121 is shown in FIG. 7. As shown in this figure, the customer profile data 121 is data relating to customers, and is equipped with a customer profile storage column 1211 which stores a customer profile for specifying a customer, and a solution needs profile storage column 1212 which stores a solution needs profile for specifying needs of a solution. The customer profile 1211 is equipped with a customer ID storage column 1211a for storing a customer ID which is given to each customer for specifying a customer, a customer name storage column 1211b, which is a name of a customer, and a customer data storage column 1211c such as telephone numbers and addresses. In addition, the solution needs profile 1212 is equipped with a business type storage column 1212a, a business condition storage column 1212b, a use application storage column 1212c, a scene storage column 1212d, and technology (restriction) needs storage column 1212e.

The client computer 101 attains the above-mentioned functions, in the same manner, by CPU executing a program stored in a storage device. Meanwhile, the data storage device 114 may be attained on the server computer 106 or the client computer 101, and may be attained by an independent external storage device.

In addition, it is all right even if the client computer 101 and the server computer 106 are attained by one information processing device. In this case, the communication network 105 is unnecessary. Furthermore, it is all right even if a plurality of client computers 101 exist. In this case, it is possible for a plurality of users to execute the value creating scenario describing program 112 on the server computer 106, independently.

In addition, it is possible for the user operation section 102 of the client computer 101 to utilize a screen display application such as Java on a display screen which is attained by the output section 103, on the occasion of inputting.

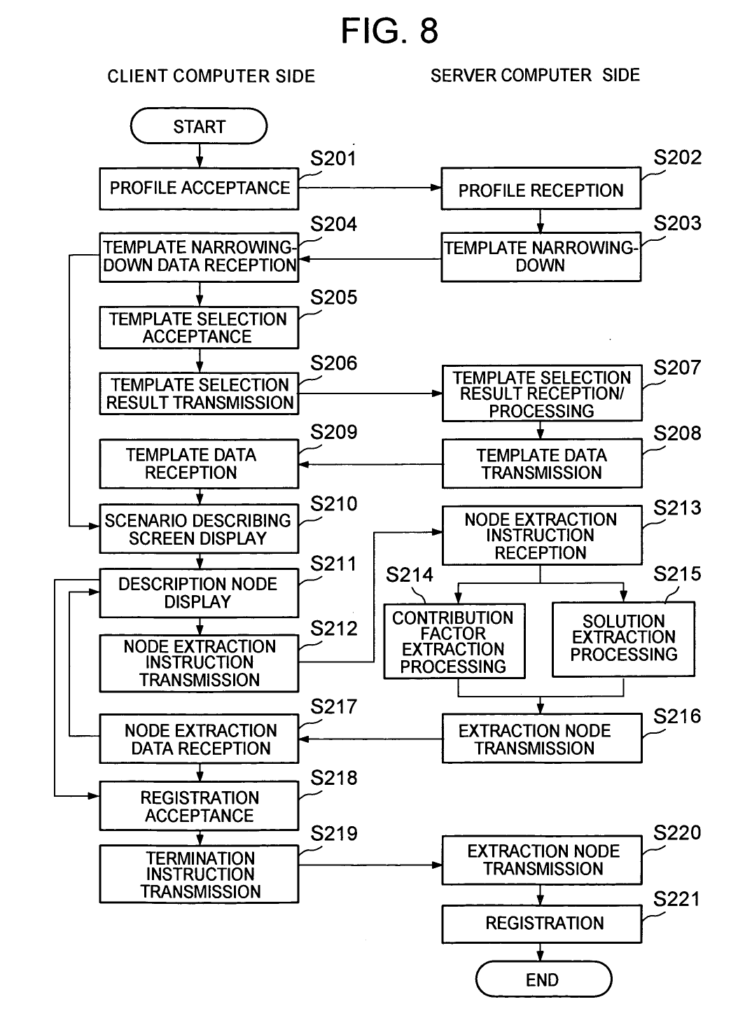

Next, processing of customer-value creating scenario formation supporting processing in this embodiment, which is attained by the client computer 101 and the server computer 106, will be explained. FIG. 8 shows a processing flow of the customer-value creating scenario formation supporting processing in this embodiment.

The client computer 101 receives an input of the customer profile data 121 through a display screen of the output section 103, after log-in processing. When receiving an input of profile data of a customer as a scenario formation object, from a user, the client computer 101 transmits the profile data to the server computer 106 as customer profile data (step S201) When receiving customer profile data from the client computer 101 (step S202), the server computer 106 carries out template narrowing-down processing through the use of the template selection 107, by using the customer profile data, and extracts available template data 122 from the template data 122 stored in the data storage device 114, and transmits the extracted available template data as the template narrowing-down data to the client computer 101 at a customer profile data transmission source (step S203). Meanwhile, detail of the template narrowing-down processing will be described later.

When receiving the template narrowing-down data (step S204), the client computer 101 displays the received template narrowing-down data on the output section 103, and receives a selection from a user (step S205), and transmits a selection result to the server computer 106 (step S206).

Here, in case that there is no desired template data 122 in a narrowing-down result, it is possible for a user not to select the template data 122. In the step S204, in case that an instruction of a selection from a user is not received for a predetermined period of time, after display, or in case that an instruction, which means that template data 122 is not selected, is received from a user, the client computer 101 transmits a result which means that template data 122, which was presented by a user, is not selected, to the server computer 106.

The control section 113 of the server computer 106, which received the selection result, gives a new template ID to selected template data 122 in the template narrowing-down data, and further, replaces case name and solution needs profiles with the customer profile data received in the step S202, and stores them in respective storage columns (step S207). Then, the control section 113 transmits them to the client computer 101, together with scenario describing screen formation data (step S208).

Meanwhile, in case of having received a result which means that a user does not select template data 122, the control section 113 of the server computer 106 generates new template data 122 with no stored data, and gives anew template ID thereto, and stores the customer profile data received in the step S202, as case name and solution needs profiles, in respective storage columns (step S207), and transmits them to the client computer 101, together with scenario describing screen formation data (step S208).

The client computer 101, which has received the template data 122 and the scenario describing screen formation data (step S209), carries out display of the scenario describing screen 600 by the data, on the output section 103 (step S210) Meanwhile, in case when the template narrowing-down data, i.e., candidate template data 122 is one, as a result of narrowing down templates in the step S203, it may be configured in such a manner that the server computer 106 transmits the template data 122 and the scenario describing screen data 126 at a time point of the step S203 and the client computer 101 carries out display processing of the step S210.

At this time, the scenario describing screen 600, which is displayed on the output section 103 of the client computer 101, is as shown in, for example, FIG. 6. A user carries out node description processing on the scenario describing screen 600 displayed on the output section 103, by use of an input device such as a mouse, and adds a necessary node. In this embodiment, for example, when a value node which represents “value” as the type is to be added, it is possible by processing for selecting a node which is prepared in a tool column in advance, from the tool column 610 and dragging and dropping it on the value node description column 623. By this operation, a node, in which a type is a value, is newly generated. It is possible for a user to input name, attribute data of the newly generated node, through a keyboard etc., after this processing.

Here, the scenario describing screen 600, which is displayed in case that a selection of template data 122 is not carried out, appears as illustrated in the figure where no node is displayed on the scenario area 620.

When the client computer 101 receives processing of attribute data of the newly generated node from a user, the control section 104 adds the attribute data to the data storage column 1224 of the template data 122 which is now displayed on the screen, and displays the template data 122 on the output section 103 additionally (step S211). Meanwhile, attribute data, which is received as an input from a user at this time and relates to the new data, is finally transmitted to the server computer 106, and additionally registered in the attribute data 123 by the result processing section 111 of the server computer 106.

At this time, the user can not only add a new node by providing description by himself but by extracting contribution factor extraction processing. In addition, it is possible to obtain a solution by solution extraction processing. In case of having received pushing-down of the contribution factor extraction button 631 or the solution extraction button 632 from a user (step S212), the client computer 101 transmits the instruction to the server computer 106.

The server computer 106, which received the above-mentioned instruction from the client computer 101 (step S213), has the contribution factor extraction processing section 109 or the solution extraction processing section 110 executed contribution factor extraction processing (step S214) and solution extraction processing (step S215) respectively, in accordance with the received instruction. Details of the both processing will be described later. When a node is extracted by the both processing, a name and a type of the extracted node are transmitted to the client computer 101 as contribution factor extraction data or solution extraction data (step S216).

The client computer 101, which received the extracted contribution factor extraction data or solution extraction data (step S217), adds the extracted contribution factor extraction data or the solution extracted data to the data storage column 1224 of template data 122 which is now displayed on the output section 103, and displays the extracted contribution factor extraction data or the solution extracted data additionally on a predetermined area of the scenario describing screen 600 which is displayed on the output section 103 (step S211).

The client computer 101 receives an operation of a node addition from a user, a contribution factor extraction instruction, and a solution extraction instruction, until the client computer 101 receives pushing-down of the registration button 612, and repeats processing from the steps S211 through S217 every time it receives. The number of reception is not an issue. In the step S211, when pushing-down of the registration button 612 is received after a description node is displayed, the process proceeds on to a step S218.

When receiving pushing-down of the registration button 612 (step S218), the client computer 101 transmits a termination instruction to the server computer 106 together with template data 122 at that time point and attribute data 123 added in the step S211 (step S219).

Receiving the template data 122, the attribute data 123 and the termination instruction (step S220), the server computer 106 registers the received template data 122 as new template data 122 additionally in the data storage device 144, and registers the received attribute data 123 as new attribute data 123 additionally to attribute data 123 (step S221), and terminates processing. Thereafter, the user can extract this template as necessary, by a template ID and a case name etc.

Next, detail of template narrowing-down processing in the step S203 will be explained.

Basically, data of the customer profile data 121, which matches to data stored in the solution needs profile storage column 1212, extracts template data which has been stored in the solution needs profile storage column 1223 of the template data 122. At this time, although a data indicating “not specified” is stored in the solution needs profile storage column 1223 of the template data 122, it is judged as being matched. For example, a template, in which data showing “not specified” is stored in any solution needs profile storage column 1223 and which can be utilized regardless of all business types and business conditions, is extracted as a template which matches to, in any narrowing-down.

Meanwhile, in this embodiment, it is configured so as to extract such a thing that all solution needs profiles accord, as described above, but it is not limited to this. It may be configured so as to extracts a template that only a predetermined element accords, among constituent elements of a solution needs profile. In this case, it may be configured so as to additionally transmit data for specifying whether templates are narrowed down by accord of which item, on the occasion that a user transmits a customer profile to the server computer 106. That is, in the step S201, the client computer 101 is configured to transmit a condition for narrowing down template data 122 together with customer profile data. Then, the server computer 106 narrows down template data 122, in accordance with a received condition.

Next, detail of contribution factor extraction processing in the step S214 will be hereinafter explained.

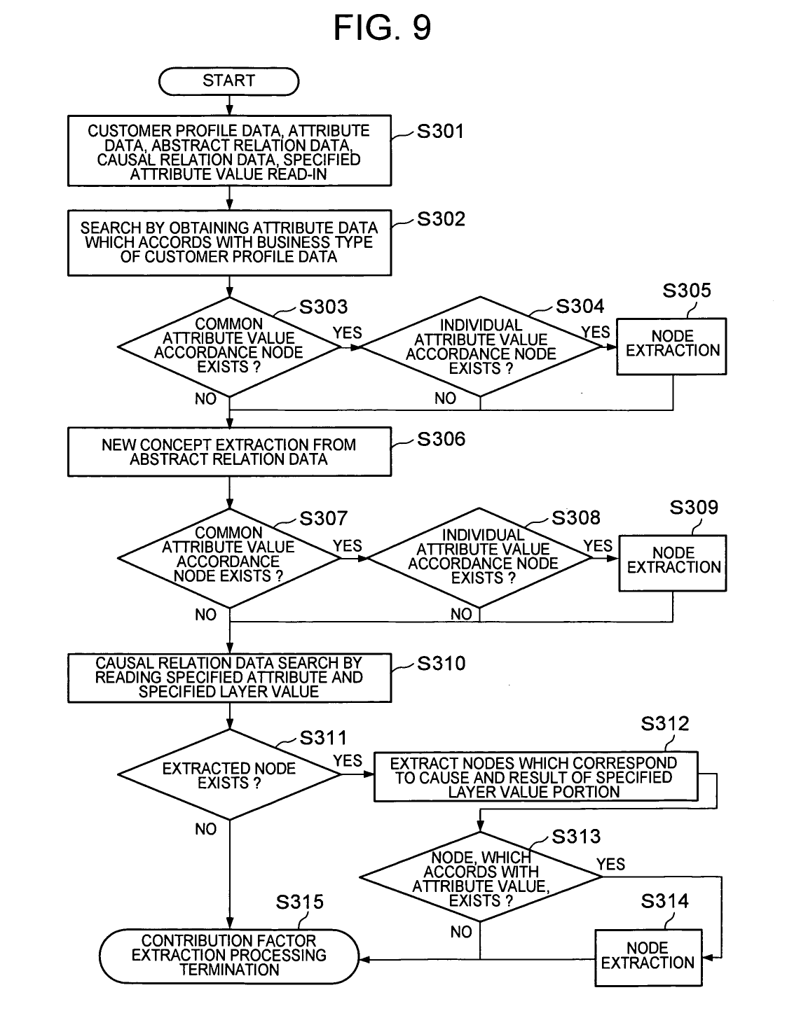

FIG. 9 shows a processing flow of the contribution factor extraction processing. This processing is attained by the contribution factor extraction processing section 109 on the server computer 106.

When a contribution factor extraction instruction is received, the contribution factor extraction processing section 109 obtains customer profile data 121, attribute data 123, abstract relation data 124, and causal relation data 125, and obtains, as a specified attribute, an attribute which was instructed by a user as an attribute to be searched for extracting a relevant node (step S301).

Here, the contribution factor extraction processing section 109 transmits extraction condition setup screen data to the client computer 101, for receiving a specified attribute from a user, i.e., for receiving an input of a condition for extracting a relevant node. The client computer 101 displays an extraction condition setup screen 700 which is generated from extraction condition setup screen data, on the output section 103.

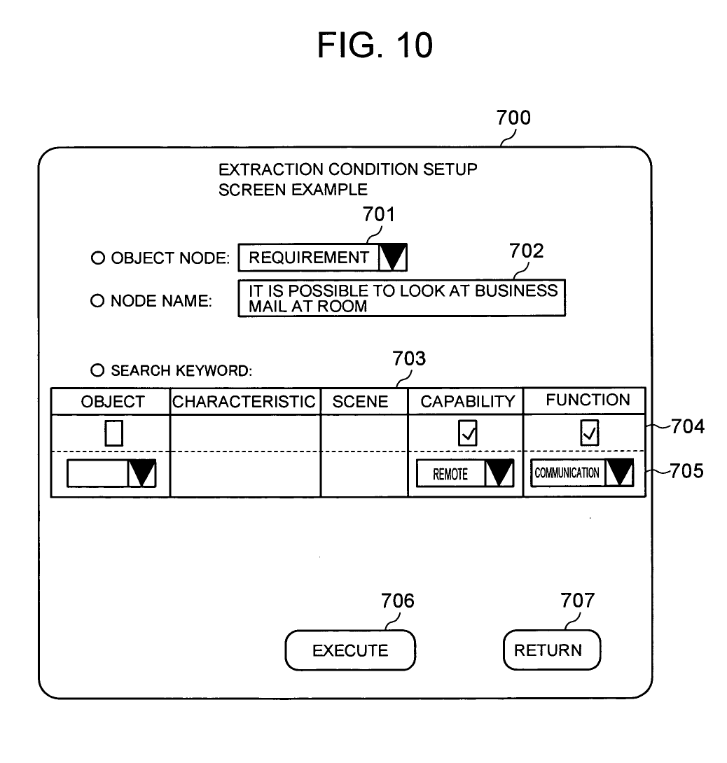

FIG. 10 shows one example of the extraction condition setup screen 700. As shown in this figure, the extraction condition setup screen 700 is equipped with an object node instruction column 701 for receiving a selection of a type of a node which becomes an object for extracting a relevant node, a node name input column 702 for receiving an input of a name of a node, a search keyword input column 703 for receiving an input of a search keyword, an execution button 706 for receiving an instruction for transmitting an inputted content to the server computer 106, and a “return” button 707 for receiving an instruction for disabling an instruction inputted on this screen and returning to previous processing.

In this embodiment, for example by receiving an instruction for selecting a predetermined node on the scenario describing screen 600 by a mouse click etc., and thereafter, receiving pushing-down of the contribution factor extraction button 631, the contribution factor extraction processing section 109 judges that it received a contribution factor extraction instruction which relates to the node. A node selected at this time is used as an object node, and as to the object node instruction column 701 and the node name input column 702, relevant ones are automatically extracted from the attribute data 123 and displayed.

Meanwhile, in case that a user does not select a node, the object node instruction column 701 and the node name input column 702, the search keyword input column 703 are empty columns, and search conditions are directly inputted to the object node instruction column 701 and the search keyword input column 703.

The search keyword input column 703 is equipped with a search object column 704 for receiving an input of an instruction of whether it is used as a search object, from a user, and an attribute display column 705 for showing an attribute of a node which has been set up in the node name input column 702.

Here, explanation in terms of the node name “to enable reading office mails at home” will be described as an example. In the attribute data 123, a type of this node is a requirement, and therefore, attributes are set up to an object column 123d, a capability column 123g, a function column 123h, a role column 123i, and a place column 123j. The object, the capability, and the function are the specific attributes for nodes whose type is classified as a requirement, therefore, with regard to he object column 123d, the capability column 123g and the function column 123h, can be selected as a search object. The contribution factor extraction processing section 109 obtains an attribute of an individual attribute for which an instruction to be used as a search object is received from a user, and a role and a place which are common attributes, as specified attributes, and obtains respective attribute values.

For example, in an example shown in FIG. 10, a capability attribute (remote) and a function attribute (communication) as an individual attribute, and an attribute such as a role (business person) and a place (hotel) as a common attribute become specified attributes. Words in parentheses respective attribute values.

The contribution factor extraction processing section 109 extracts data which is classified in a business type which matches to a business type of the customer profile data 121, from the attribute data 123 (step S302).

Then, a data which matches to a specified attribute value is extracted. Here, firstly, a data which matches to a common attribute value is extracted (step S303). In case when there is a data which matches is found, such a data that an individual attribute value matches to is further extracted from it (step S304). Then, the contribution factor extraction processing section 109 holds the extracted node (step S305), and goes on to the step S306. In the steps S303 and S304, in case that no data matches to, it proceeds on to the step S306.

In the steps S303 and S304, in case that no data matches to, or after processing of the step S305 is completed, the contribution factor extraction processing section 109 moves to causal relation search processing. In the causal relation search processing, it extracts another concepts which relates to a common attribute and is bound up as the same higher concept, in accordance with the abstract relation data 124 (step S306), and extracts such a thing that an individual attribute value matches to (step S308), from a thing which relates to respective concepts and in which a common attribute value matches to (step S307). Then, the contribution factor extraction section 109 holds the extracted node (step S309).

In this embodiment, for example, according to the attribute data 123, a thing which relates to a role, in a common attribute in which a node name is “it is possible to look at a business mail at a room” is a “business person”. According to the abstract relation data 124, a higher concept of the business person is a “hotel guest”, and as another data which has the same “hotel guest” as a higher concept, it is possible to obtain a “tourist”. As to data in which a role is the “tourist” from attribute data 123 with the same business type, processing of the above-mentioned steps S307 and S308 is carried out.

When extraction is completed in the step S305 and the step S309, the contribution factor extraction processing section 109 transmits extraction result screen data for displaying an extraction result as an extraction result screen 800, to the client computer 101. The client computer 101 displays the extraction result screen 800 on the output section 103 on the basis of received data.

The contribution factor extraction processing section 109 receives a selection of a node to be added, from the extracted node, from a user, through this screen. In addition, a user, in case of further desiring to carry out extraction of a node, can input an instruction for continuing extraction to which a causal relation, that will be described later, is added (instruction for moving to causal relation search condition setup processing).

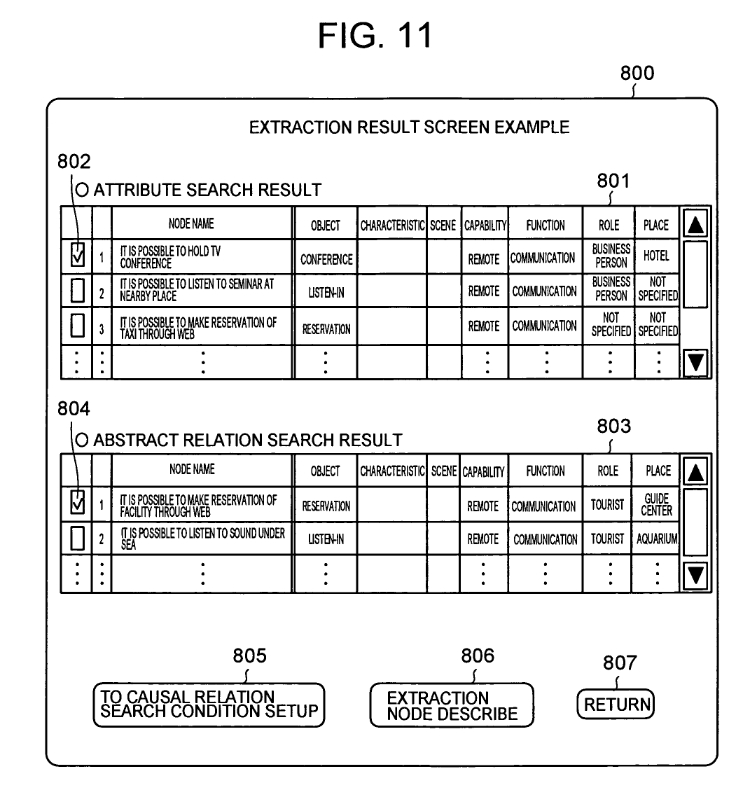

One example of the extraction result screen 800 is shown in FIG. 11. As shown in this figure, the extraction result screen 800 is equipped with an attribute search result display column 801 for displaying a extraction result in the step S305, and an abstract relation search result display column 803 for displaying an extraction result in the step S309. Each of the attribute search result display column 801 and the abstract relation search result display column 803 displays an extracted node, and is equipped with selection columns 802, 804 for receiving an instruction from a user as a node to be added.

The extraction result screen 800 is equipped with a causal relation search condition setup move instruction button 805 for receiving an instruction for moving to causal relation search condition setup processing, an extraction node description instruction button 806 for receiving an instruction for additionally displaying a node, which was selected by a user, on a template, and a “return” button 807 for disabling an instruction which was made on this screen, and receiving an instruction for returning to previous processing.

When receiving an instruction of the extraction node description instruction button 806, the contribution factor extraction processing section 109 transmits a relevant node to the client computer 106, and displays it on a relevant place of the scenario describing screen 600.

On one hand, in case that an instruction of the causal relation search condition setup move instruction button 805 was received, or in case that no data matches to, in the steps S307, S308, the contribution factor extraction processing section 109 moves to causal relation search condition setup processing.

Here, the contribution factor extraction processing section 109 transmits a specified layer value of a subject node data and data of a screen for receiving an input of a causal relation specified value (causal relation search condition setup screen 900), to the client computer 101, and receives an instruction of a search scope from a user. Expansion of a search scope is carried out in accordance with causal relation data 125 in which a causal relation between nodes was set up.

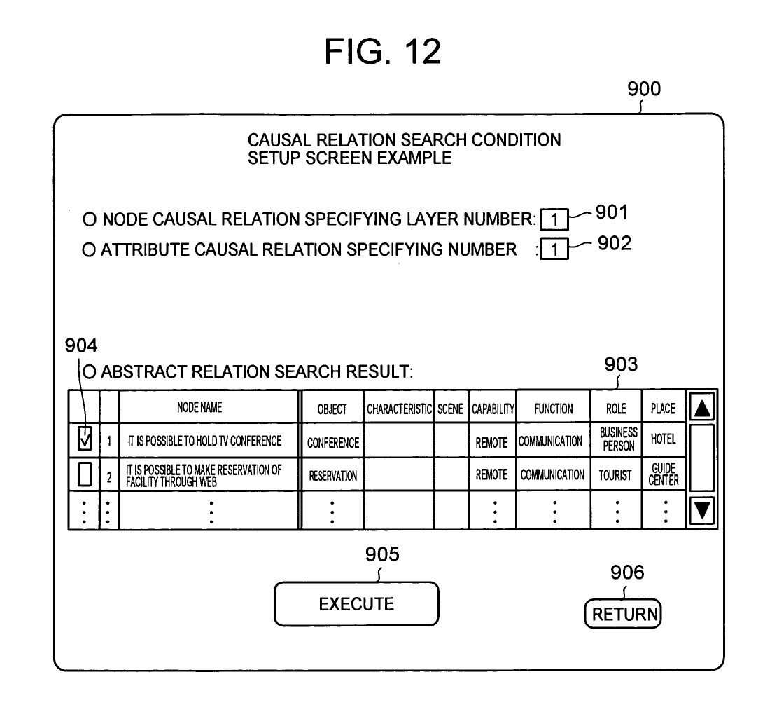

One example of the causal relation search condition setup screen 900 is shown in FIG. 12. As shown in this figure, the causal relation search condition setup screen 900 is equipped with a node causal relation specifying layer number input column 901 for specifying a layer of a search scope of a causal relation of nodes, an attribute causal relation specifying number input column 902 for specifying an extraction number of nodes having an attribute value which matches to an attribute value of a specified attribute of attributes that nodes, which correspond to a cause and a result in the causal relation of the nodes, have, an object node selection column 903 for displaying a node which can be selected by a causal relation search, an execution button 905 for receiving an instruction of a processing execution, and a “return” button 906 for receiving an instruction for returning to previous processing without executing processing.

On the object node selection column 903, displayed are a node which was specified by a user at the time of contribution factor extraction processing start, and a node which was extracted in the steps S305, S309. In addition, the object node selection column 903 is equipped with a selection instruction column 904 for receiving an instruction of whether a causal relation search of a node is carried out or not, with respect to each node.

When receiving a specified layer number, a causal relation specifying number, and an instruction of a selection of a node, through the causal relation search condition setup screen 900 (step S301), the contribution factor extraction processing section 109 extracts a node which has a causal relation with the selected node, for each specified layer, in accordance with causal relation data 125 (steps S311, S312) Then, in case that there is a node having an attribute value which matches to an attribute value of an specified attribute received in the step S301 and an attribute value expanded in the step S306, in the extracted each node (step S313). The node is extracted and held (step S314).

When extraction is completed, the contribution factor extraction processing section 109 transmits data for displaying an extraction result as a causal relation extraction result display screen 1000, to the client computer 101. The client computer 101 displays the causal relation extraction result display screen 1000 on the output section 103, on the basis of received data.

The contribution factor extraction processing section 109 accepts a selection of anode to be added from a user, through this screen.

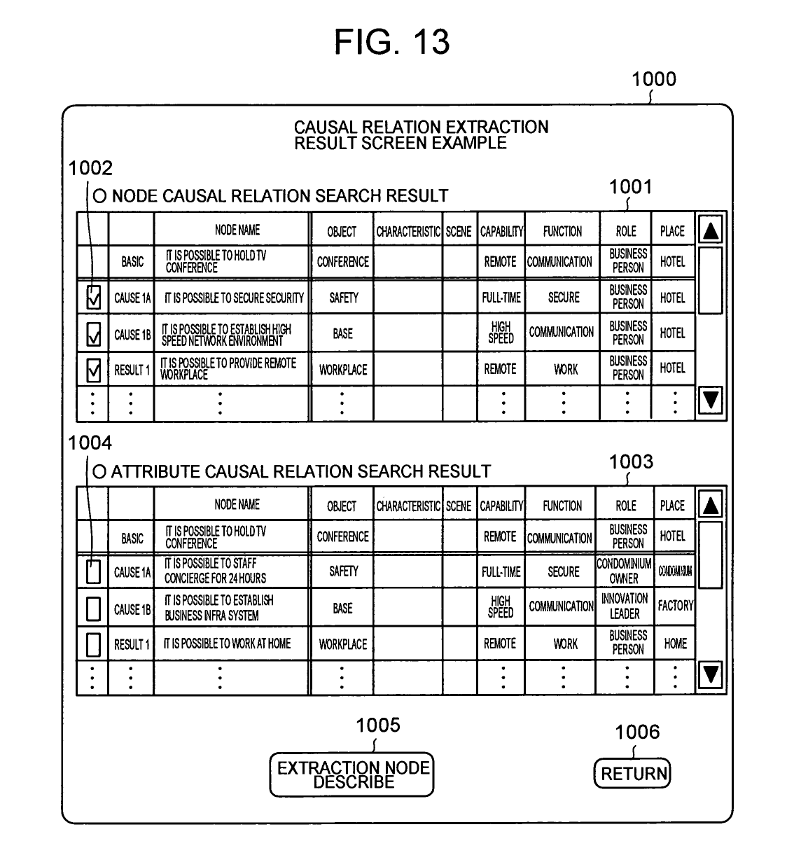

One example of the causal relation extraction result display screen 1000 is shown in FIG. 13. As shown in this figure, the causal relation extraction result display screen 1000 is equipped with a node causal relation search result display column 1001 for displaying a result of extracting a thing in which attribute data matches to, from those extracted in accordance with a specified layer number, and an attribute causal relation search result display column 1003 for displaying a result of extracting a thing in which attribute data matches to, from those extracted in accordance with a specified search number. Each of the node causal relation search result display column 1001 and the attribute causal relation search result display column 1003 is equipped with selection instruction columns 1002 and 1004 for accepting an instruction of a selection of a node to be added, respectively.

The causal relation extraction result display screen 1000 is further equipped with an extraction node description instruction button 1005 for receiving an instruction for additionally displaying a node selected by a user on a template, and a “return” button 1006 for disabling an instruction made on this screen and receiving an instruction for returning to previous processing.

When receiving an instruction of the extraction node description instruction button 1005, the contribution factor extraction processing section 109 transfers a relevant node to the control section 113 as contribution factor extraction data. The control section 113 transmits contribution factor extraction data to the client computer 101, and displays an extracted node on a relevant place of the scenario describing screen 600.

After the above-described processing is completed, or in case that no relevant node is extracted in the step S312, the contribution factor extraction processing section 109 terminates contribution factor extraction processing (step S315).

As above, contribution factor extraction processing by the contribution factor extraction processing section 109 was explained. Here, in this embodiment, it is essential that a common attribute, which does not depend on a type of a node, matches to, at the time of node extraction processing, but it is not limited to this.

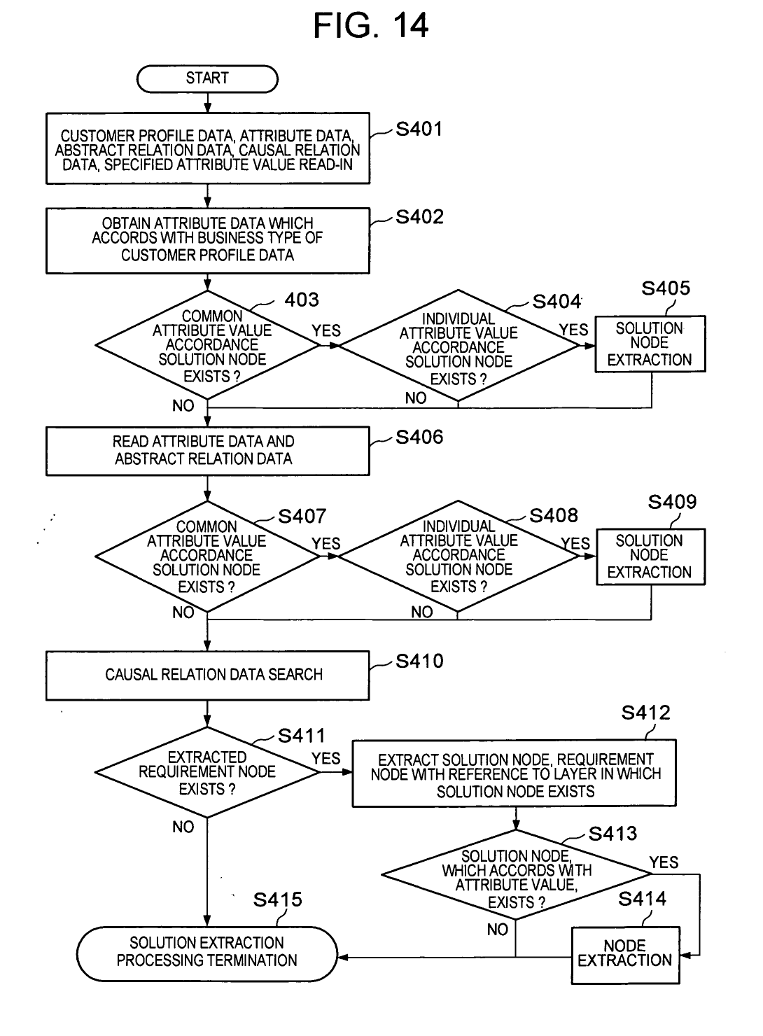

Next, detail of solution extraction processing in the step S215 will be explained. FIG. 14 shows a processing flow of solution extraction processing in this embodiment. This processing is attained by the solution extraction processing section 110.

When receiving an instruction of solution extraction processing, the solution extraction processing section 110 obtains customer profile data 121, attribute data 123, abstract relation data 124 and causal relation data 125, and obtains an attribute specified as an attribute to be searched for extracting a relevant node from a user, and obtains their attribute values, respectively (step S401).

Meanwhile, an instruction of solution extraction processing is made only in case that a specified node is a requirement node. In addition, reception of an instruction of an extraction condition is basically the same as the same processing in the contribution factor extraction processing. In this regard, however, this processing is set up in such a manner that a selection of a function of an attribute is essential.

The solution extraction processing section 110 extracts data which is classified in a business type which matches to a business type of customer profile data 121 and in which a type is classified as a solution, from attribute data 123 (step S402).

Then, the solution extraction processing section 110 extracts such a node that a specified attribute value matches to. Firstly, the solution extraction processing section 110 extracts such a node that an attribute value of a common attribute matches to (step S403). In case that there is a node which matches to, the solution extraction processing section 110 further extracts a node that an attribute value of an individual attribute matches to from the node extracted at step S403 (step S404). Then, the solution extraction processing section 110 holds the extracted node (step S405), and goes to a step S406. Meanwhile, in case that no nodes matches to, in the steps S403 and S404, it goes to the step S406.

In case that no nodes matches to in the steps S403, S404, or after processing of the step S405 is completed, the solution extraction processing section 110 moves to causal relation search processing. In the causal relation search processing, the solution extraction processing section 110 extracts another concepts which relates to a common attribute and is bound up as the same higher concept, in accordance with the abstract relation data 124 (step S406), and extracts a node that an individual attribute value matches to (step S408), from a node whose common attribute value matches to for each concept (step S407). Then, the solution extraction section 110 holds the extracted node (step S409).

When extraction in the step S405 and the step S409 is completed, the solution extraction processing section 110 transmits extraction result screen data for displaying an extraction result as the extraction result screen 800, to the client computer 101. The client computer 101 displays the extraction result screen 800 on the output section 103 on the basis of received data.

The solution extraction processing section 110 receives a selection of a node to be added, from the extracted node, from a user, through this screen. In addition, in case that a user further desires to carry out extraction of a node, the solution extraction processing section 110 receives an instruction for continuing extraction to which a causal relation is added.

When receiving an instruction of the extraction node description instruction button 806, the solution extraction processing section 110 transmits a relevant node to the client computer 106, and displays the relevant node on a relevant place of the scenario describing screen 600.

On one hand, in case that an instruction of the causal relation search condition setup move instruction button 805 was received, or in case that no nodes matches to, in the steps S407, S408, the solution extraction processing section 110 moves to causal relation search condition setup processing.

In the solution extraction processing, specification of a layer number is not received through the causal relation search condition setup screen 900. In the solution extraction processing, as to a node which was specified initially, or each node extracted so far, causal relation data 125 is referred, to carry out extraction up to a layer where a solution node exists (step S410). In case of referring to 2 layers or more up to a solution node, a requirement node between them is extracted (steps S411, S412).

In case that there is a node having an attribute which matches to an attribute value of a specified attribute received in the step S401 and an attribute value expanded in the step S406, in each node extracted (step S413), the node is extracted and held (step S414).

When extraction is completed, the solution extraction processing section 110 transmits data for displaying an extraction result as the causal relation extraction result display screen 1000, to the client computer 101. The client computer 101 displays the causal relation extraction result display screen 1000 on the output section 103, on the basis of received data.

The solution extraction processing section 110 accepts a selection of a node to be added from a user, through this screen.

When accepting an instruction of the extraction node description instruction button 1005, the solution extraction processing section 110 transfers a relevant node to the control section 113 as solution extraction data. The control section 113 transmits solution extraction data to the client computer 101, and displays the extracted node on a relevant place of the scenario describing screen 600.

After the above-described processing is completed, or in case that no relevant nodes are extracted in the step S412, the solution extraction section 110 terminates solution extraction processing (step S415).

Here, in this embodiment, it is essential that a common attribute, which does not depend on a type of a node, matches to, at the time of node extraction processing, but it is not limited to this.

As explained above, according to the customer-value creating scenario description supporting system in this embodiment, by clarifying what is a value for a customer, and supporting formation of a customer-value creating scenario for realizing that value, even a person in charge having little experience can form the customer-value creating scenario. In case of proposing a solution for solving a problem of a customer, it is possible to realize a higher appealing proposal, by using this customer-value creating scenario. This customer-value creating scenario can be used as some help for a solution proposal which met a customer-value, also on the occasion of carrying out business planning etc.

Furthermore, according to the customer-value creating scenario description supporting system in this embodiment, it is possible to support formation of a customer-value creating scenario which reflects a demand of each customer, and therefore, by clearly demonstrating a customer-value creating scenario formed by this support, it becomes possible to make a convincing proposal which convinces “individual” customers.

That is, according to the customer-value creating scenario description supporting system in this embodiment, it becomes possible to make supporting for broadening an idea of a logical configuration which is coupled to a value reflecting demands of various customers, and deriving requirements and solutions which are really necessary for customers, and forming a value creating scenario for a realizing customer-value, and it becomes possible to realize improvement of appeal power in a solution proposal, and development support of a solution in business planning.

1. A customer-value creating scenario formation supporting apparatus which supports formation of a scenario for deriving a solution which is coupled to a value of a customer,
the apparatus comprising:
data storage means which holds attribute data which comprises a name and an attribute of a node described in the scenario, wherein the node meaning a value, a requirement and a solution, abstract relation data that rules a hierarchical relation between the nodes on a conceptual basis, and causal relation data that rules a causal relation between the nodes;
node description means which describes the node inputted from a user, in the scenario;
contribution factor extraction means which extracts a node relating to a node described by the node description means, by use of the attribute data, abstract relation data and causal relation data, and adds the node extracted to the scenario;
solution extraction means which extracts a node that becomes a solution of the node described by the node description means and the node extracted by the contribution factor extraction means, by use of the attribute data, abstract relation data and causal relation data, and adds the node extracted to the scenario; and
scenario output means which presents a new scenario having a node described by the node description means, a node added by the contribution factor extraction means, and a node added by the solution extraction means, to a user.

2. The customer-value creating scenario formation supporting apparatus as set forth in claim 1, further comprising:
template selection means; and
scenario formation means,
wherein
the data storage means further holds template data in which a predetermined node is described and which is the scenario, and
the template selection means selects available template data from template data held in the data storage means, on the basis of a characteristic of a customer which is specified by a user, and
the contribution factor extraction means further extracts a node that relates to a node described in the selected template data, and adds the node extracted to the scenario, and
the solution extraction means further extracts a node which becomes a solution of a node described in the selected template data and adds the node extracted to the scenario, and
the scenario formation means adds a node described by the node description means and a node extracted by the contribution factor extraction means, and a node extracted by the solution extraction means, to the selected template data, to form a new scenario.

3. The customer-value creating scenario formation supporting apparatus as set forth in claim 2, further comprising:
result processing means which adds a scenario formed by the scenario formation means to the data storage means as the template data, and adds a node name and attribute relating to a new node added by the node description means, to the data storage means as the attribute data.

4. The customer-value creating scenario formation supporting apparatus as set forth in claim 1 wherein
the attribute data comprises a node name, a node type, and a node attribute, and
the node type is a value, an equipment, and a solution, and
the node attribute comprises an individual attribute in which a relevant attribute differs depending on a type of the node, and a common attribute which does not depend on a type of the node, and
the abstract relation data is defined in association with the common attribute, and
the contribution factor extraction means extracts a node having the same values relating to the common attribute and the individual attribute of the attribute data as those of the existing node, and further extracts a node having the same value relating to the individual attribute from those having attribute values belonging to the same higher concept as to the common attribute in the extracted node, the existing node and the abstract relation data, and further extracts a node for which a causal relation is defined in association with each of all extracted nodes and the existing node in the causal relation data, and
the solution extraction means extracts a node which has the same values relating to the common attribute and the individual attribute of the attribute data as those of a node which is the existing node and in which a type of the node is a requirement, and a node in which a type of the node is a solution, and further extracts a node which has the same value relating to the individual attribute and in which a type of the node is a solution, from those having attribute values which belongs to the same higher concept as to the common attribute in a node which is the existing node and in which a type of the node is a requirement and the abstract relation data, and further extracts a node for which a causal relation is defined in association with a node which is the existing node and in which a type of the node is a requirement, in the causal relation data.

5. A customer-value creating scenario formation supporting system which supports formation of a scenario for deriving a solution which is coupled to a value of a customer, the system comprising:
a client computer which provides an interface to a user; and
a server computer which supports formation of a scenario, in accordance with an instruction of a user which is received through the client computer;
wherein
the client computer comprises:
operation means which receives an input from a user, and
output means which presents a processing result in the server computer to a user, and
the server computer comprises:
data storage means which holds template data that a predetermined node is described and is the scenario, the node meaning a value, a requirement, and a solution, attribute data that is composed of a name and an attribute of a node described in the scenario, abstract relation data that rules a hierarchical relation between the nodes on a conceptual basis, and causal relation data that rules a causal relation between the nodes;
template selection means which selects predetermined template data from the template data;
contribution factor extraction means which extracts a relevant node, by use of the attribute data, abstract relation data and causal relation data, from nodes existing in template data selected by the template data selection means;
solution extraction means which extracts a node that becomes a solution, by use of the attribute data, abstract relation data and causal relation data, from nodes existing in template data selected by the template data selection means and a node extracted by the contribution factor extraction means; and
scenario formation means which adds a node extracted by the contribution factor extraction means and a node extracted by the solution extraction means to template data selected by the template data selection means, to form a new scenario, wherein
the user operation means receives input of customer information by the user, and
the template selection means selects the template in accordance with the customer information received by the user operation means, from template data held in the data storage means.

6. A customer-value creating scenario formation supporting method which supports formation of a scenario for deriving a solution which is coupled to a value of a customer, the method comprising:
a node description step which describes a predetermined node, which is inputted from a user and means a value, a requirement and a solution, in the scenario;
a contribution factor extraction step which extracts a node relating to a node described in the node description step, by use of attribute data which is composed of a name and an attribute of a node described in the scenario, abstract relation data which rules a hierarchical relation between the nodes on a conceptual basis, and causal relation data which rules a causal relation between the nodes, and adds the node extracted to the scenario;
a solution extraction step which extracts a node that becomes a solution of a node described in the node description step and a node extracted in the contribution factor extraction step, by use of the attribute data, the abstract relation data and the causal relation data, and adds the node extracted to the scenario; and
a scenario output step which presents a new scenario having a node described in the node description step, a node extracted in the contribution factor extraction step, and a node added in the solution extraction step, to a user.

7. The customer-value creating scenario formation supporting method as set forth in claim 6, further comprising:
a customer information reception step which receives an input of information of a customer as the scenario formation object, from a user; and
a template selection step which selects available template data on the basis of the customer information, from template data in which the node was described and which is the scenario, before the contribution factor extraction step;
wherein
in the contribution factor extraction step, a node relating to a node described in the selected template data is further extracted and added to the scenario.

8. A customer-value creating scenario formation supporting program which is used for supporting formation of a scenario which derives a solution coupled to a value of a customer, the program when executed by a computer, renders the computer to execute:
a customer information reception step which receives an input of information of a customer as a scenario formation object, from a user;
a template selection step which selects available template data on the basis of the customer information, from template data in which a predetermined node, which means a value, a requirement and a solution, was described and which is the scenario;
a contribution factor extraction step which extracts a relevant node, by use of attribute data held in advance which is composed of a name and an attribute of a node described in the scenario, abstract relation data which rules a hierarchical relation between the nodes on a conceptual basis, and causal relation data which rules a causal relation between the nodes, from nodes existing in the selected template data;
a solution extraction step which extracts a node that becomes a solution, by use of the attribute data, the abstract relation data and the causal relation data, from nodes existing in template data selected in the template selection step and a node extracted in the contribution factor extraction step; and
a scenario formation step which adds a node extracted in the contribution factor extraction step and a node extracted in the solution extraction step to template data selected in the template data selection step, to form a new scenario.
